(19) United States
(12) Patent Application Publication
(10) Pub. No.: US 2007/0271118 A1
(43) Pub. Date: Nov. 22, 2007

(54) Sales force sculpting method and system

(76) Inventor: William R. Wilp, Annandale, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/438,623

(22) Filed: May 22, 2006

(51) Int. Cl. G06Q 10/00; G06Q 50/00; G07G 1/14

(52) U.S. Cl. 705/2; 705/14

(57) ABSTRACT

A system and method target health care providers and their patients for promotion of an alternate drug treatment. The alternate drug treatment is directed at replacing multiple drug treatments with a single drug that treats more than one symptom simultaneously. The patient segment to be targeted is identified by determining a link between a drug product, a patient, and the patient's health care provider, based upon drug prescription and drug buying behavior of the health care providers. Analysis of the members of the patient segment is used for market and product forecasting, epidemiology, sales force sizing and targeting, and in-depth marketing analysis.

### BACKGROUND OF THE INVENTION

1. Field of the Invention

The present invention relates to marketing of pharmaceutical products; more particularly, to a method and system for determining a link between a drug product and patients likely to benefit from treatment with the product.

2. Description of the Prior Art

At this point in time, pharmaceutical sales representatives spend a great deal of time traveling, talking with pharmacists, hospital personnel, physicians, patient advocacy groups, and even retirement homes, in order to increase the visibility of their company's products and sales. Traditional approaches in pharmaceutical sales rely on casting a wide net in the hopes of gaining a large return. Target market selection and product positioning are not efficiently aligned and therefore a shotgun approach is relied upon to try and link the target market with products. As a result, there is an inefficient expenditure of resources, money and time by the pharmaceutical company. Only three in ten prescription drugs reach the market with revenues that match or surpass research and development costs.

Accordingly, there exists a need in the art to determine a link between a given drug product and the characteristics of patients in need of the product, in order to determine the market segment or submarket, which is the best target for the drug.

### SUMMARY OF THE INVENTION

The present invention provides a method and system for determining the target market and product positioning crucial to an efficient pharmaceutical marketing plan. Toward this end, drug prescription data, drug purchasing data, patient symptom data, and patient demographic data are collected from medical providers. The patient symptom data are matched with a pharmacopoeia of drug treatments, the pharmacopoeia indicating which symptoms and diseases each drug is designed to treat. Each drug, which treats more than one symptom, is thereby identified. From the prescription data, it is determined which patients suffer from more than one symptom. Then the patient symptoms are matched with the multi-symptom drug treatments to identify which patients can be treated for more than one symptom, simultaneously, with a single drug.

The number of patients which can be treated in this way is calculated and their demographics identified. Accordingly, a sub-segment of the patient population, which can benefit from treatment with the multi-symptom drugs, is identified. The health care provider prescription and drug purchasing data indicates which health care providers are not treating these patients with the identified multi-symptom treatment drugs, for the simultaneous treatment of more than one symptom. The identified sub-segment of the patient population and the identified health care providers are targeted for advertising and promotion.

Furthermore, drug treatments vary as to their efficacy in treating more than one symptom. The greater the overlap, i.e. ability to treat more than one symptom, the more likely the drug is to be adopted for this purpose. Accordingly, the drug treatments can be classified into categories based upon their degree of overlap and positioned for marketing to reflect this overlap.

In some cases, a sub-group of patients with the same multiple symptoms is identified but there is no matching single drug to treat the multiple symptoms. The cost of developing such a drug can be estimated. If the number of members of the sub-group, who are potential purchasers of the drug, is greater than a predetermined threshold, then the new drug is targeted for development.

### BRIEF DESCRIPTION OF THE DRAWINGS

The invention will be more fully understood and further advantages will become apparent when reference is had to the following detailed description and the accompanying drawings, in which like numerals refer to like parts:

FIG. 1 is a method of targeting health care providers for promotion of an alternate drug treatment;

FIG. 2 is a diagram of the present invention illustrating patient segmentation;

FIG. 3 is diagram of the present invention illustrating positioning of a drug to treat overlapping symptoms;

FIG. 4 is a diagram of the present invention illustrating a system for targeting health care providers for promotion of an alternate drug treatment; and

FIG. 5 is a diagram of the present invention illustrating data flow in a system for targeting health care providers for promotion of an alternate drug treatment.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical pharmaceutical marketing method and system. Those of ordinary skill in the art will recognize that other elements are desirable and/or required in order to implement the present invention. However, because such elements are well known in the art, and because they do not facilitate a better understanding of the present invention, a discussion of such elements is not provided herein.

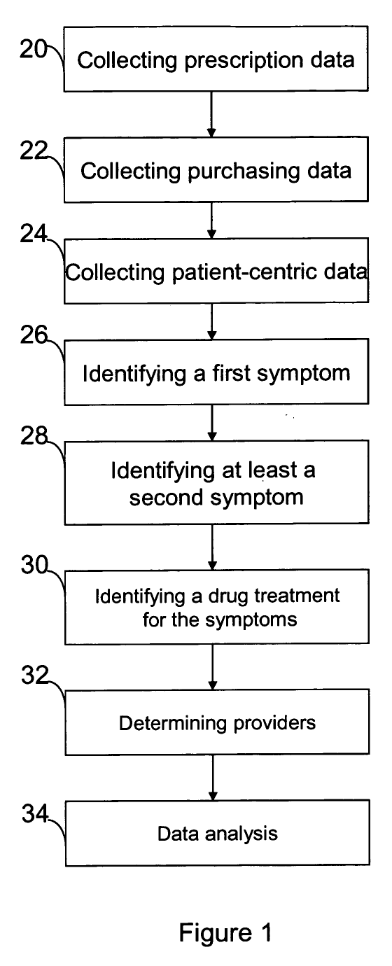

FIG. 1 is an illustration of the current invention's method of targeting health care providers and their patients for promotion of an alternate drug treatment. In this method, an innovative forecasting methodology is used to identify links between product positioning and patient segments based upon physician buying behavior. In step 20, prescription data from a pool of health providers is collected. Pharmaceutical companies generally have access to prescriber-level prescription data which includes ratios of drug use by therapeutic class and brand, average length of therapy by drug and class, average daily or weekly dosing by drug, persistency by drug class and drug, prescriber specialty, and region of the country. In step 22, drug purchasing data is collected. This information is readily available to pharmaceutical companies through their own records as well as published sources, such as drug purchasing cooperatives, and private research. In step 24, patient-centric data such as patient age, gender, diagnosis, treatment, ratio of diagnosed patients to treated patients by disease, treatment type, treated vs. untreated ratios, ratios of different drug therapies by diagnosis, and the like are aggregated from medical plans and other sources.

From these data, in steps 26 and 28 patient symptoms are identified and patients who exhibit more than one symptom are further identified. In step 30, a drug treatment for simultaneous treatment of a combination of these symptoms is identified from a pharmacopoeia or drug company information. In step 32, providers who are not purchasing the drug (identified in step 22) or prescribing the drug (identified in step 20) are differentiated and flagged as potential targets for marketing a drug treatment for multiple symptoms, identified in step 30. If no drug is identified, the need indicates that a new drug treatment should be considered for development. In addition, in step 34, data analysis of the potential targets takes place, including the characteristics of both the health care providers and the patients of the health care providers to be targeted. This information is readily available from the patient-centric data collected in step 20 and the purchasing and prescription data collected in steps 22 and 20, respectively.

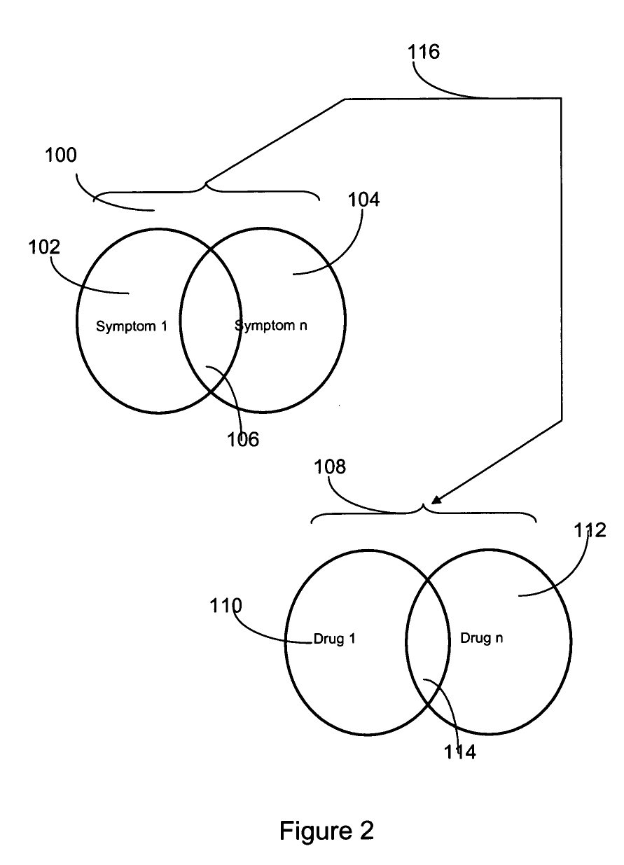

An example of an application of the invention is depicted in FIG. 2. In this example a first symptom is asthma 102 and a second symptom is trouble sleeping 104. Patients may have an unlimited number of symptoms, which can be targeted, however, only two are featured in this example. Some number of these patients exhibits both symptoms, i.e. overlapping symptoms 106. Likewise, there may be more than two overlapping symptoms. Patients exhibiting the overlapping symptoms constitute a patient segmentation or submarket 100. They are the target market for a drug which treats both symptoms simultaneously. Some of these patients are under treatment for their symptoms and this is reflected in physician buying behavior 116. Physicians may be treating each symptom with a different drug. For example the physician may be treating the asthma 102 with Advair 110 and the trouble sleeping 104 with Ambien 112. The overlap 114 shown indicates the target market for an alternate drug, which can treat both symptoms simultaneously.

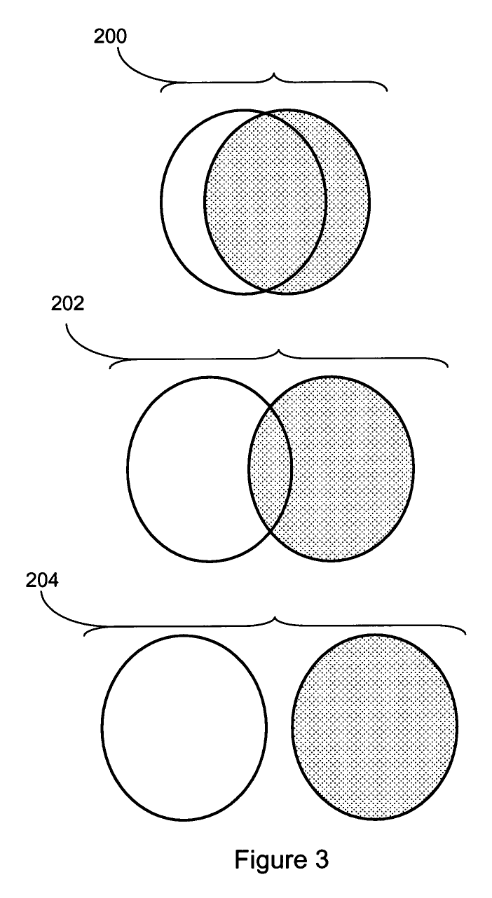

FIG. 3 is a visual representation of the types of target markets and their positioning. The best positioning 200 is represented by a large overlap in symptoms in the patient population. In this case, for example, many patients would exhibit asthma and trouble sleeping simultaneously. Uncertain positioning is represented by a small overlap 202 in which a smaller group of patients exhibit both symptoms simultaneously. A situation in which a there would be no target market for a drug, which treats both symptoms simultaneously, is depicted in 204.

Determining the target market and product positioning is crucial to an efficient marketing plan. A target market is the market segment (the market divided into submarkets) to which a particular product is marketed, often defined in the pharmaceutical field by age, gender, symptoms, and patients' health needs. The present invention determines a link between a drug product, a patient, and the patient's health care provider in order to determine a patient segment or target market.

The market strategy utilized by the present invention provides market and product forecasting, epidemiology, sales force sizing and targeting and in-depth marketing analyses. By correlating a patient segment and physician buying behavior, efficient marketing targets for new drugs, pharmaceutical research and development, as well as marketing for existing products can be determined.

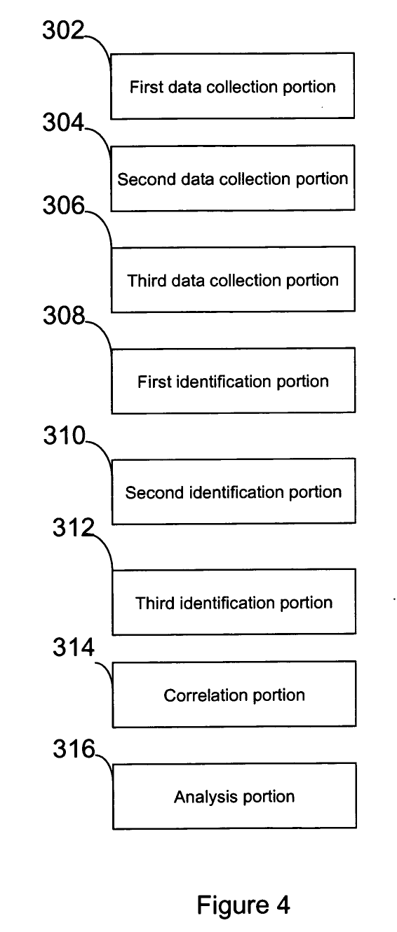

FIG. 4 depicts a system for targeting health care providers for promotion of an alternate drug treatment. The first data collection portion 302 collects drug prescription data from health care providers. This can be accomplished by scanning, data entry, dictation followed by digitization or any of the other well-known methods. The second data collection portion 304 collects drug purchasing behavior from health care providers. Likewise, this can be accomplished through well-known methods such as electronic data interchange (EDI), downloading information from websites, database queries, any of the above-mentioned methods, or other methods well-known in the art. The third data collection portion 308 collects patient-centric data from health care providers, which can be accomplished through voice mail, email, any of the above-mentioned methods, or other methods well-known in the art.

The first identification portion 308 and second identification portion 310 search the prescription data collected from the first data collection portion 302 and the patient-centric data collected from the third data collection portion 306 to identify which patients have more than one symptom being treated and which drugs are being used in the treatment. The third identification portion 312 identifies an alternate drug to be used to treat more than one of these symptoms simultaneously. This can be determined by searching pharmaceutical company information or a pharmacopoeia. The correlation portion 314 identifies the patients with multiple symptoms, which make them candidates for being treated with the alternate drug treatment identified by the third identification portion 312. The correlation portion 314 also determines which health care providers are not offering the alternate treatment based upon the drug purchasing information collected by the second data collection portion 304 and the drug prescription data collected by the first data collection portion 302. The identified patients and their health care providers are targets for marketing of the alternate drug therapy.

The analysis portion 316 determines a demographic patient profile for the patients identified by the correlation portion 314, based upon the patient-centric data collected by the first identification portion 308. Accordingly, information such as the age, gender, race, and geographic location of these identified patients is known. This information is used to position the alternate drug treatment, especially with respect to competing products, by creating a product identity customized for patients exhibiting the demographic profile and for health care providers servicing these patients. Such information is also used for creating an epidemiological profile, with techniques well-known in the art, revealing the possible causes and distribution of the symptoms. Furthermore, the number of patients calculated by the analysis portion 316 enables product sales forecasting as well as sales forecasting.

The degree to which a single alternate drug treatment can replace more than one drug treatment determines the overlap multiple, which is calculated by the analysis portion 316. Elements which are used alone or in combination to calculate this multiple include: the number of patients identified by the correlation portion 314; the total number of different symptoms simultaneously treatable by the alternate drug treatment, identified by the third identification portion 312; the total number of different symptoms, treatable by the alternate drug treatment, which each patient identified by the correlation portion 314 exhibits; and the efficacy of the treatment as measured by treatment studies. The overlap multiple determines the positioning or marketing category of the alternate drug treatment as depicted in FIG. 3.

Additionally, elements of the overlap multiple are used to determine whether or not to develop a new alternate drug treatment. So, for example, where there is a need for a drug to treat multiple symptoms simultaneously, as measured by the number of patients exhibiting multiple symptoms FIG. 1 step 30 and no such treatment is available, a forecasted revenue can be estimated. By subtracting the cost of development from the forecasted revenue a profit is estimated and used to determine whether development would be worthwhile.

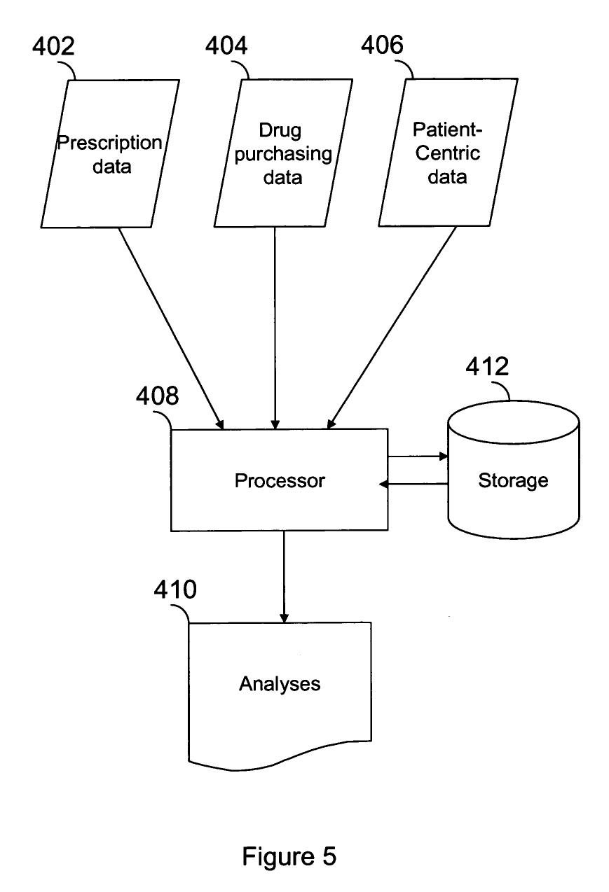

FIG. 5 illustrates the data flow in the system of the present invention. Patient prescription data 402, health care provider drug purchasing data 404, and patient-centric data 406 are fed into a processor 408 and stored in permanent storage 412. The processor 408 performs the tasks of correlating the data to identify the patient and health care provider segment of interest and formulating and outputting the analyses 410.

Those of the ordinary skill in the art will recognize that many modifications and variations of the present invention may be implemented without departing from the spirit or scope of the invention. The foregoing description and the following claims are intended to cover all such modifications and variations.

What is claimed is:

1. A method of targeting health care providers for promotion of an alternate drug treatment comprising the steps of:
a. collecting drug prescription data of at least one health care provider;
b. collecting drug purchasing behavior of the at least one health care provider;
c. collecting patient-centric data of the at least one health care provider;
d. identifying a first disease symptom of at least one patient from a potential treatment pool of patients of the health care provider;
e. identifying at least one second disease symptom of the at least one patient; and
f. identifying an alternate drug treatment for treating simultaneously the first disease symptom and the at least one second disease symptom;
wherein the drug prescription data of the at least one health care provider demonstrates that the at least one patient is not being treated with the alternate drug treatment, and the drug purchasing behavior of the at least one health care provider demonstrates that the health care provider is not purchasing the alternate drug treatment.

2. The method of claim 1, further comprising the step of calculating the number of patients in the potential treatment pool that exhibit the first disease symptom and the at least one second disease symptom and are not being treated with the alternate drug treatment.

3. The method of claim 1, further comprising the step of creating a demographic patient profile for the patients in the potential treatment pool that exhibit the first degree symptom and the at least one second disease symptom and are not being treated with the alternate drug treatment.

4. The method of claim 3, further comprising the step of calculating a sales force size based upon the number of patients to be served.

5. The method of claim 3, further comprising the step of forecasting product sales based upon the number of patients to be served.

6. The method of claims 2 and 3, further comprising the step of creating an epidemiological profile based upon the demographics and the number of patients to be treated.

7. The method of claims 2 and 3, further comprising the step of positioning the alternate drug treatment, vis-à-vis competitive products, by creating a product identity customized for patients exhibiting the demographic profile.

8. The method of claims 2 and 3 further comprising the step of computing an overlap multiple based upon: 1) the number of patients who exhibit the first degree symptom and the at least one second disease symptom; 2) the total number of different symptoms which are simultaneously treatable by the alternate drug treatment; 3) the total number of different symptoms, treatable by the alternate drug treatment, which each patient exhibits; and 4) the efficacy of the treatment wherein the foregoing are applied to the calculating the overlap multiple singly or in combination.

9. The method of claim 8, further comprising the step of categorizing the alternate drug treatment based upon a threshold value of the overlap multiple.

10. The method of claim 8, further comprising the step of developing a marketing plan for the alternate drug treatment based upon the overlap multiple.

11. A method for determining whether a new drug therapy for treating a plurality of patient symptoms simultaneously should be developed, comprising the steps of:
a. collecting drug prescription data of at least one health care provider;
b. collecting drug purchasing behavior of the at least one health care provider;
c. identifying a sub group of patients with the plurality of symptoms, under treatment by the at least one health care provider, each symptom being treated with a different drug treatment;
d. calculating the number of patients within the subgroup;
e. estimating a cost of developing a single drug to treat the plurality of symptoms based upon historical data;
f. calculating a difference between a forecasted revenue from sales of the new drug therapy to the identified sub group and the estimated cost of developing the drug therapy; and
g. developing the drug therapy when the difference is positive.

12. A method of targeting health care providers for promotion of an alternate drug treatment, comprising the step of:
identifying a patient pool served by at least one health care provider in which at least one patient exhibits more than one medical condition and receives treatment with a separate and distinct drug for each of the more than one medical conditions, the alternate drug treatment being a simultaneous treatment for at least more than one of the conditions which the patient exhibits, and the at least one health care provider not currently prescribing the alternate drug treatment.

13. A system for targeting health care providers for promotion of an alternate drug treatment comprising:
a. a first data collection portion for collecting drug prescription data of at least one health care provider;
b. a second data collection portion for collecting drug purchasing behavior of the at least one health care provider;
c. a third data collection portion for collecting patient-centric data of the at least one health care provider;
d. a first identification portion for identifying a first disease symptom of at least one patient from a potential treatment pool of patients of the health care provider;
e. a second identification portion for identifying at least one second disease symptom of the at least one patient; and
f. a third identification portion for identifying an alternate drug treatment for treating simultaneously the first disease symptom and the at least one second disease symptom,
wherein the first data collection portion demonstrates that the at least one patient is not being treated with the alternate drug treatment, and the second data collection portion demonstrates that the health care provider is not purchasing the alternate drug treatment.

14. The system of claim 13, further comprising means of calculating the number of patients in the potential treatment pool that exhibit the first disease symptom and the at least one second disease symptom and are not being treated with the alternate drug treatment.

15. The system of claim 13, further comprising means of creating a demographic patient profile for the patients in the potential treatment pool that exhibit the first degree symptom and the at least one second disease symptom and are not being treated with the alternate drug treatment.

16. The system of claim 15, further comprising means of calculating a sales force size based upon the number of patients to be served.

17. The system of claim 15, further comprising means of forecasting product sales based upon the number of patients to be served.

18. The system of claims 14 and 15, further comprising means of creating an epidemiological profile based upon the demographics and the number of patients to be treated.

19. The system of claims 14 and 15, further comprising means of positioning the alternate drug treatment, vis-à-vis competitive products, by creating a product identity customized for patients exhibiting the demographic profile.

20. The system of claims 14 and 15, further comprising means of computing an overlap multiple based upon: 1) the number of patients who exhibit the first degree symptom and the at least one second disease symptom; 2) the total number of different symptoms which are simultaneously treatable by the alternate drug treatment; 3) the total number of different symptoms, treatable by the alternate drug treatment, which each patient exhibits; and 4) the efficacy of the treatment, wherein the foregoing are applied to the calculating the overlap multiple singly or in combination.

21. The system of claim 20, further comprising means of categorizing the alternate drug treatment based upon a threshold value of the overlap multiple.

22. The system of claim 21, further comprising means of developing a marketing plan for the alternate drug treatment based upon the overlap multiple.
